(19) United States
(12) Patent Application Publication
(10) Pub. No.: US 2021/0221355 A1
(43) Pub. Date: Jul. 22, 2021

(54) APPARATUS AND METHOD FOR GENERATING U-TURN PATH OF AUTONOMOUS VEHICLE

(71) Applicants: Hyundai Motor Company, Seoul (KR); Kia Motors Corporation, Seoul (KR)

(72) Inventor: Dong Hoon Kang, Seoul (KR)

(21) Appl. No.: 17/037,913

(22) Filed: Sep. 30, 2020

(30) Foreign Application Priority Data
Jan. 17, 2020 (KR) 10-2020-0006664

(51) Int. Cl. B60W 30/045; B60W 30/095

(52) U.S. Cl. CPC B60W 30/045; B60W 2554/404; B60W 30/095

(57) ABSTRACT

A method of generating a U-turn path of an autonomous vehicle is provided. The method includes generating a plurality of virtual path points on a high definition map based on driving environment information and generating a reference path corresponding to the U-turn situation When a preceding vehicle is present ahead of the vehicle, a moving trajectory of the preceding vehicle is followed and a candidate path is generated. The reference path is compared with the candidate path to generate an optimum U-turn path.

### CROSS-REFERENCE TO RELATED APPLICATION(S)

This application claims the benefit of Korean Patent Application No. 10-2020-0006664, filed on Jan. 17, 2020, which is hereby incorporated by reference as if fully set forth herein.

### BACKGROUND

### Field of the Disclosure

The present disclosure relates to a technology of generating a path for autonomous driving, and more particularly, to an apparatus and method for generating a U-turn path of an autonomous vehicle for generating a U-turn path based on sensor information and applying a moving trajectory of a preceding vehicle and determination of the reliability of a sensor to dynamically correct a path, and thus, the vehicle may be actively controlled in various U-turn interruption situations.

### Discussion of the Related Art

In a conventional autonomous vehicle, to make a U-turn, an autonomous vehicle pre-generates a U-turn path based on sensor information and then controls the vehicle. However, when the U-turn path is generated based on the sensor information only, there is a limit in actively handling the following restriction.

For example, for U-turn control, at least three lanes need to be ensured at an opposite side, and in this regard, when an illegal parking vehicle is present in one lane of the three lanes, it is difficult to immediately generate an alternative path for avoiding collision and there is a risk that a secondary accident occurs in the case of sudden braking. In addition, conventionally, a U-turn path is generated based on sensor information, and thus, when a dead zone is generated in a portion of a field of view of a sensor due to surrounding vehicles that stand by in a U-turn lane, the reliability of the path is degraded and path interruption occurs before and behind the dead zone.

### SUMMARY

Accordingly, the present disclosure is directed to an apparatus and method for generating a U-turn path of an autonomous vehicle for generating a U-turn path based on sensor information and determining both a moving trajectory of a preceding vehicle and the reliability of a sensor to dynamically correct a path, and thus, the reliability may be prevented from being degraded due to a dead zone of a sensor, and the vehicle may be actively controlled in various U-turn interruption situations.

The technical problems solved by the exemplary embodiments are not limited to the above technical problems and other technical problems which are not described herein will become apparent to those skilled in the art from the following description.

To achieve these objects and other advantages and in accordance with the purpose of the disclosure, as embodied and broadly described herein, a method of generating a U-turn path of an autonomous vehicle may include recognizing a U-turn situation, generating a plurality of virtual path points on a high definition map based on driving environment information and generating a reference path corresponding to the U-turn situation, when a preceding vehicle is present ahead of the vehicle, following a moving trajectory of the preceding vehicle and generating a candidate path, and comparing the reference path with the candidate path and generating an optimum U-turn path.

The generating of the reference path may include calculating a first path equation based on an n^{th} degree polynomial (where n is a natural number equal to or greater than 3) for each path section between adjacent virtual path points of the plurality of virtual path points. The calculating of the first path equation may include calculating a coefficient of the first path equation for each path section using position coordinates and a heading angle of the vehicle and a curvature and curvature rate at each of the virtual path points.

The generating of the candidate path may include generating a contour corresponding to the preceding vehicle based on data collected using a distance measuring sensor, and extracting a center point of the contour, accumulating and acquiring position coordinates of the center point for each time sampling, and generating the moving trajectory of the preceding vehicle. The generating of the candidate path may further include extracting a plurality of follow path points corresponding to a plurality of virtual path points, respectively, from the moving trajectory of the preceding vehicle, and calculating a second path equation based on an n^{th} degree polynomial (where n is a natural number equal to or greater than 3) for each path section between adjacent follow path points among the plurality of follow path points.

Additionally, the generating of the optimum U-turn path may include calculating an error between coefficients of the first and second path equations for each path section, and when the error is equal to or greater than a preset threshold value, generating the U-turn path through curve fitting of a polynomial for each path section based on the second path equation. The generating of the optimum U-turn path may include, when the error is less than the preset threshold value, generating the U-turn path through curve fitting of a polynomial for each path section based on the first path equation.

The method may further include estimating reliability of the driving environment information. The generating of the optimum U-turn path may include, when the reliability is less than a preset reference value, comparing the reference path with the candidate path. The determining of the reliability may include determining the reliability of the driving environment information in consideration of a field of view of each sensor and a blind spot due to a surrounding vehicle.

### BRIEF DESCRIPTION OF THE DRAWINGS

The accompanying drawings, which are included to provide a further understanding of the disclosure and are incorporated in and constitute a part of this application, illustrate exemplary embodiment(s) of the disclosure and together with the description serve to explain the principle of the disclosure. In the drawings:

FIG. 1 is a block diagram showing a U-turn path generating apparatus of an autonomous vehicle (hereinafter, referred to as a ‘U-turn path generating apparatus’) according to an exemplary embodiment of the present disclosure;

FIG. 2 is a diagram illustrating a method of generating a reference path by a U-turn path generating apparatus according to an exemplary embodiment of the present disclosure;

FIG. 3 is a diagram illustrating a method of generating a candidate path by a U-turn path generating apparatus according to an exemplary embodiment of the present disclosure;

FIGS. 4A-4B are diagrams illustrating a method of determining the reliability of a sensor by a U-turn path generating apparatus according to an exemplary embodiment of the present disclosure;

FIG. 5 is a diagram illustrating a method of generating an optimum U-turn path by a U-turn path generating apparatus according to an exemplary embodiment of the present disclosure; and

FIG. 6 is a flowchart illustrating a method of generating a U-turn path of an autonomous vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments will be described in detail with reference to the attached drawings. The exemplary embodiments may, however, be embodied in many alternate forms and the disclosure should not be construed as limited to the embodiments set forth herein. Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the exemplary embodiments as defined by the claims.

The terms such as “first” and “second” are used herein merely to describe a variety of constituent elements, but the constituent elements are not limited by the terms. The terms are used only for the purpose of distinguishing one constituent element from another constituent element. In addition, terms defined in consideration of configuration and operation of exemplary embodiments are used only for illustrative purposes and are not intended to limit the scope of the exemplary embodiments.

The terms used in the present specification are used for explaining a specific exemplary embodiment, not limiting the present disclosure. Thus, the singular expressions in the present specification include the plural expressions unless clearly specified otherwise in context. Also, the terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

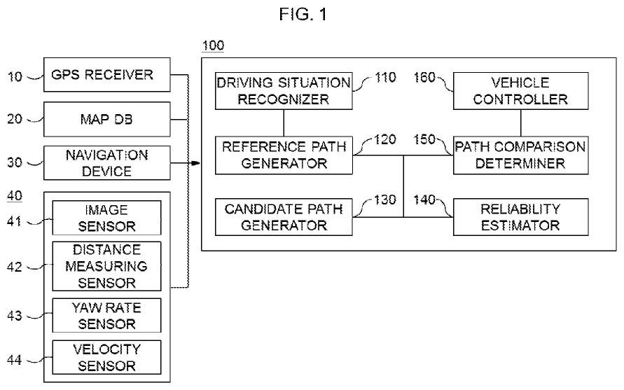

Hereinafter, a U-turn path generating apparatus of an autonomous vehicle according to an exemplary embodiment of the present disclosure will be described with reference to the accompanying drawings. FIG. 1 is a block diagram showing a U-turn path generating apparatus of an autonomous vehicle (hereinafter, referred to as a ‘U-turn path generating apparatus’) according to an exemplary embodiment of the present disclosure. Referring to FIG. 1, a U-turn path generating apparatus 100 according to an exemplary embodiment may include a driving situation recognizer 110, a reference path generator 120, a candidate path generator 130, a reliability estimator 140, a path comparison determiner 150, and a vehicle controller 160.

The driving situation recognizer 110 may be configured to collect information on a driving environment through a global positioning system (GPS) receiver 10, a map database (DB) 20, a navigation device 30, and a sensor unit 40, which are installed in a vehicle, and may be configured to recognize a U-turn situation based on the information on the driving environment. The GPS receiver 10 may be a sensor configured to estimate a geolocation of the vehicle and may be configured to receive a navigation message from a GPS satellite positioned above the Earth and collect the current position (which includes a latitude and a longitude) of the vehicle in real time.

The map DB 20 may be configured to store a high definition map obtained by recording road information in units of lanes in the form of a database (DB). The high definition map may contain geographic information, lane information, road surface information, position information of an object and a traffic sign, a road mark, and the like in a digital form, and may include road network data including a node and a node. The map DB 20 may be embodied as a storage medium such as a flash memory, a hard disk, a secure digital (SD) card, a random access memory (RAM), a read only memory (ROM), or a web storage, and may be automatically updated or may be manually updated by a user with a predetermined period using wireless communication.

In response to receiving a departure point and a destination from a user, the navigation device 30 may be configured to search for a driving path of the vehicle in consideration of path costs (e.g., a shortest distance, a minimum time, or the like) and may indicate the driving path on the high definition map to provide a path guidance service. The sensor unit 40 may include an image sensor 41 and a distance measuring sensor 42, configured to detect information regarding a surrounding environment of the vehicle in real time, and a yaw rate sensor 43 and a velocity sensor 44, configured to measure information on a vehicle state.

The image sensor 41 may be configured to collect information regarding an image of a region around the vehicle, captured through an optical system, may be configured to identify color, and perform image processing (e.g., noise removal, adjustment of image quality and chroma, file compression, or the like) on the information on the image to recognize a lane, a traffic light, an obstacle, or the like on a road.

The distance measuring sensor 42 may be configured to measure a distance between the vehicle and a measurement target, and for example, may be embodied as a radio detection and ranging (RADAR), a light detection and ranging (liDAR), or the like. The RADAR may be configured to measure a distance, a direction, a relative speed, an altitude, and the like of the obstacle positioned around the vehicle using electromagnetic waves, and identify a long distance and may handle bad weather. The liDAR may be configured to generate lidar data in the form of a point from a laser pulse reflected after a laser pulse is emitted toward a front side of the vehicle on a road, and may be used to detect an object present around the vehicle by virtue of precise resolution.

The yaw rate sensor 43 may be configured to measure a yaw rate of a vehicle that autonomously travels and the velocity sensor 44 may be configured to measure a driving speed of the vehicle based on an output waveform of a wheel speed of the vehicle, which is differentially acquired. The GPS receiver 10, the map DB 20, the navigation device 30, and the sensor unit 40, which are described above, may be configured to communicate with the U-turn path generating apparatus 100 via a vehicle network (NW) (not shown), and the vehicle network (NW) may include various in-vehicle communications such as a controller area network (CAN), CAN with flexible data rate (CAN-FD), FlexRay, media oriented systems transport (MOST), or time triggered Ethernet (TT Ethernet).

The driving situation recognizer 110 may be configured to map the current position information of the vehicle that is driven autonomously along a driving path onto a high definition map and may be configured to recognize a U-turn situation ahead of the vehicle using traffic light information when the vehicle enters a U-turn lane (which refers to a lane as a partial section of a centerline, in which a U-turn area line is indicated by a white dotted line). The driving situation recognizer 110 may be configured to check whether a preceding vehicle, which stands by in the U-turn lane based on the information on a surrounding environment of the vehicle, is present.

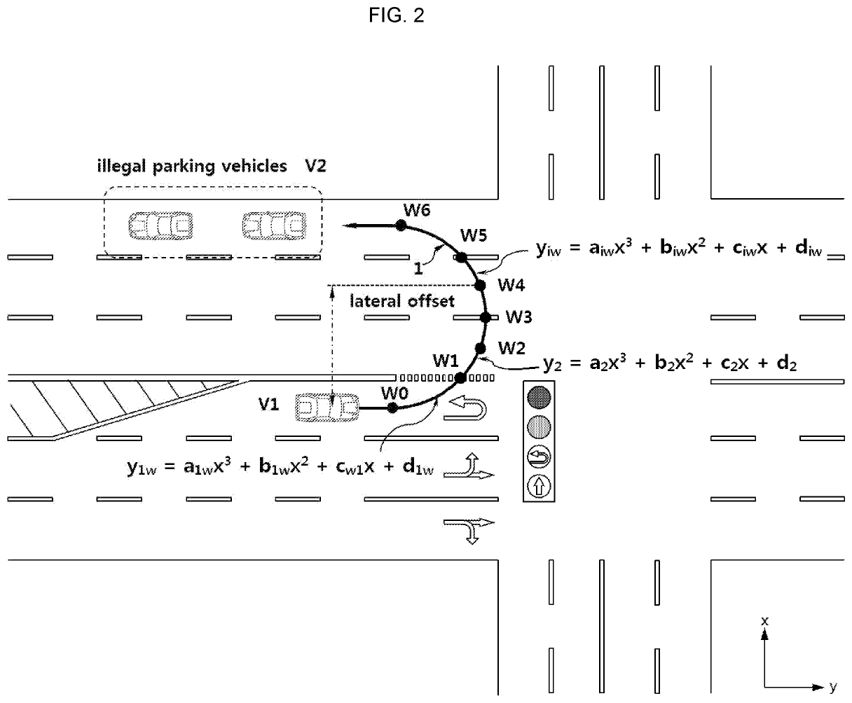

The reference path generator 120 may be configured to generate a plurality of virtual path points on the high definition map based on the driving environment information acquired from the sensor unit 40 and generate a reference path corresponding to the U-turn situation, which will be described in detail with reference to FIG. 2. FIG. 2 is a diagram illustrating a method of generating a reference path by a U-turn path generating apparatus according to an exemplary embodiment of the present disclosure.

As shown in FIG. 2, the reference path generator 120 may be configured to generate a reference path 1 for allowing a vehicle to turn by about 180 degrees from a U-turn lane and to travel in an opposite lane. The reference path generator 120 may be configured to generate a plurality of virtual path points W0 to W6 ahead of a vehicle V1 based on, for example, a look-ahead point-based guidance algorithm and may be configured to calculate a first path equation yᵢ based on an n^{th} degree polynomial (where n is a natural number equal to or more than 3) for each path section between adjacent virtual path points among the plurality of virtual path points W0 to W6. For example, the first path equation y_{iw} may be represented according to Equation 1 below.

y_{iw}+a_{iw}x³+b_{iw}x³+c_{iw}x³+d_{iw} Equation 1

wherein, a_{iw} is a curvature rate, b_{iw} is a curvature, c_{iw} is a heading angle of the vehicle V1, and d_{iw} is a lateral offset. Although a degree of the first path equation y_{iw} is assumed to be 3 in the specification, this is exemplary and the scope of the present disclosure is not limited thereto.

The reference path generator 120 may be configured to combine information regarding an environment around the vehicle V1, which is acquired through the image sensor 41 and the distance measuring sensor 42, and information regarding a state of the vehicle V1, which is acquired through the yaw rate sensor 43 and the velocity sensor 44, and may be configured to calculate coefficients a_{iw}, b_{iw}, c_{iw}, and d_{iw} of the first path equation y_{iw} for each path section in consideration of position coordinates of the vehicle V1, acquired by the GPS receiver 10. The reference path generator 120 may be configured to store a degree (n) of the calculated coefficients a_{iw}, b_{iw}, c_{iw}, and d_{iw} of the first path equation y_{iw} for each path section.

The reference path generator 120 may be configured to generate the reference path 1 through curve fitting of a polynomial of the first path equation y_{iw} for each path section. In particular, the plurality of virtual path points W0 to W6 may be present on the reference path 1. However, when U-turn control of the vehicle V1 is performed on the reference path 1 generated by combining various pieces of sensor information by the reference path generator 120, the following interruption situation may be encountered.

In general, in consideration of a turning radius of the vehicle V1, three lanes need to be ensured in an opposite lane for U-turn control. However, when an obstacle is present on the reference path 1, for example, illegal parking vehicles V2 occupy one of the three lanes, there is a limit in immediately generating an alternative path for avoiding collision and there is a risk that a secondary accident occurs in the case of sudden braking.

The reference path 1 may be generated depending on the driving environment information collected by the sensor unit 40. Thus, when a blind spot (or a dead zone) is generated in a portion of a field of view (FOV) of sensors 41 and 42 due to surrounding vehicles in the U-turn lane, the reliability of the reference path 1 may be degraded and path interruption occurs before and behind the blind spot.

Accordingly, there is a proposal of a path algorithm of previously following a moving trajectory of a preceding vehicle to generate a candidate path and providing an optimum U-turn path through comparison with a reference path to perform an immediate response to an interruption situation, for example, when a blind spot is generated in the sensors 41 and 42 due to a congestion situation in the U-turn lane or an obstacle is present in an opposite lane by the U-turn path generating apparatus 100 according to an exemplary embodiment of the present disclosure.

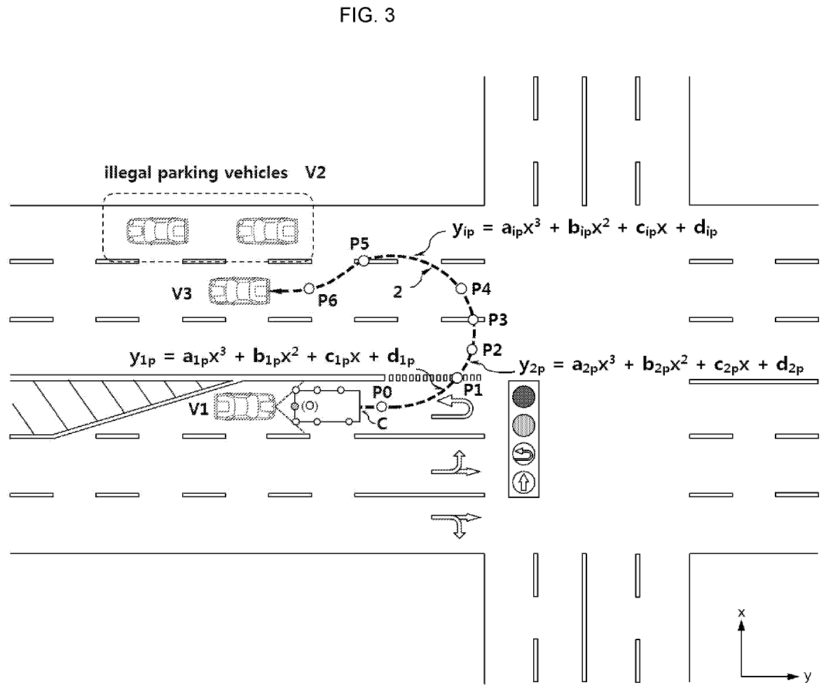

When determining that a preceding vehicle is present ahead of a vehicle through the driving situation recognizer 110, the candidate path generator 130 may follow a moving trajectory of the preceding vehicle to generate a candidate path, which will be described in more detail with reference to FIG. 3. FIG. 3 is a diagram illustrating a method of generating a candidate path by a U-turn path generating apparatus according to an exemplary embodiment of the present disclosure.

Referring to FIG. 3, the candidate path generator 130 may be configured to generate a contour C corresponding to a preceding vehicle V3 based on data collected through the distance measuring sensor 42. For example, the candidate path generator 130 may be configured to group lidar data in a point form, acquired from the distance measuring sensor 42, through clustering processing and may be configured to remove predetermined noise to generate the contour C in the form of a bounding box, corresponding to an outline of the preceding vehicle V3. Alternatively, according to another exemplary embodiment, the candidate path generator 130 may be configured to correct distortion of image information acquired through the image sensor 41 and extract a predetermine feature point corresponding to a boundary of an object to generate the contour C of the preceding vehicle V3.

The candidate path generator 130 may be configured to extract a center point O of the contour C and accumulate and acquire position coordinates of the center point O for each time sampling to generate a moving trajectory of the preceding vehicle V3. The candidate path generator 130 may be configured to extract a plurality of follow path points P0 to P6 corresponding to the plurality of virtual path points W0 to W6 (refer to FIG. 2) of a moving trajectory of the preceding vehicle V3. In particular, the plurality of follow path points P0 to P6 may have the same x coordinates (or coordinates in a horizontal direction) as those of the plurality of virtual path points W0 to W6 (refer to FIG. 2), respectively.

The candidate path generator 130 may be configured to calculate a second path equation yᵢₚ based on an n^{th} degree polynomial (where n is a natural number equal to or more than 3) for each path section between adjacent follow path points among the plurality of follow path points P0 to P6. For example, the second path equation yᵢₚ may be represented according to Equation 2 below.

yᵢₚ+aᵢₚx³+bᵢₚx³+cᵢₚx³+dᵢₚ Equation 2

wherein, aᵢₚ is a curvature rate, bᵢₚ is a curvature, cᵢₚ is a heading angle of the preceding vehicle V3, and dᵢₚ is a lateral offset. In this case, a degree of the second path equation may be dependent upon on a degree of the first path equation.

The candidate path generator 130 may be configured to calculate coefficients aᵢₚ, bᵢₚ, cᵢₚ, and dᵢₚ of second path equation yᵢₚ for each path section using a linear/nonlinear least square estimation through polynomial regression. The candidate path generator 130 may be configured to store the calculated coefficients aᵢₚ, cᵢₚ, and dᵢₚ and degree (n) of the second path equation yᵢₚ for each path section. The reliability estimator 140 may be configured to estimate the reliability of driving environment information and initiate an operation of the path comparison determiner 150, which will be described below, under a predetermined condition.

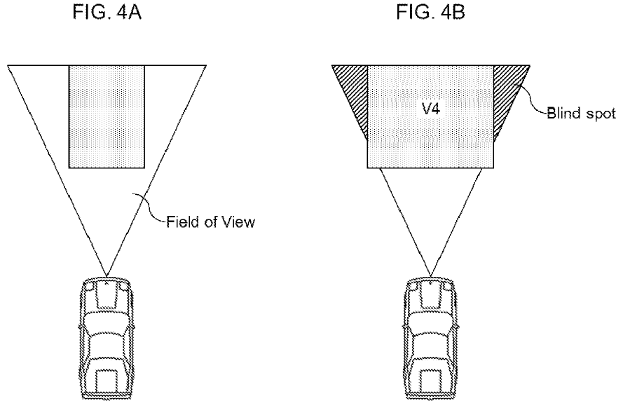

The reliability estimator 140 may be configured to estimate the reliability of the driving environment information based on a field of view (FOV) of each of the sensors 41 and 42 and a blind spot due to a surrounding vehicle, which will be described below with reference to FIGS. 4A-4B. FIGS. 4A-4B are diagrams illustrating a method of determining the reliability of a sensor by a U-turn path generating apparatus according to an exemplary embodiment of the present disclosure.

FIG. 4A shows a field of view (FOV) of each of the sensors 41 and 42, and FIG. 4B shows an example of a case in which a blind spot (or a dead zone) is generated in a portion of a field of view (FOV) of each of the sensors 41 and 42 by a surrounding vehicle V4. In particular, the field of view (FOV) refers to a maximum view range based on the specifications of each of the sensors 41 and 42.

As shown in FIG. 4B, when a blind spot is generated by the surrounding vehicle V4 and a view of each of the sensors 41 and 42 is partially hidden, there is the possibility that a vehicle, which performs U-turn control based on the reference path, collides with a vehicle that travels straight or turns to the right in an opposite lane. There is the possibility that an interval is generated between paths before and behind a blind spot based on the reference path and path interruption problem occurs.

Accordingly, the reliability estimator 140 may be configured to estimate a ratio of an actual field of view to the field of view (FOV) of each of the sensors 41 and 42 as the reliability of driving environment information, and may be configured to initiate a comparison logic between the reference path and the candidate path when the reliability is less than a preset reference value α. In particular, the actual field of view may refer to a deviation between a field of view (FOV) and a blind spot, and the reference value α is a value that is pre-tuned by a developer as minimum reliability of each of the sensors 41 and 42.

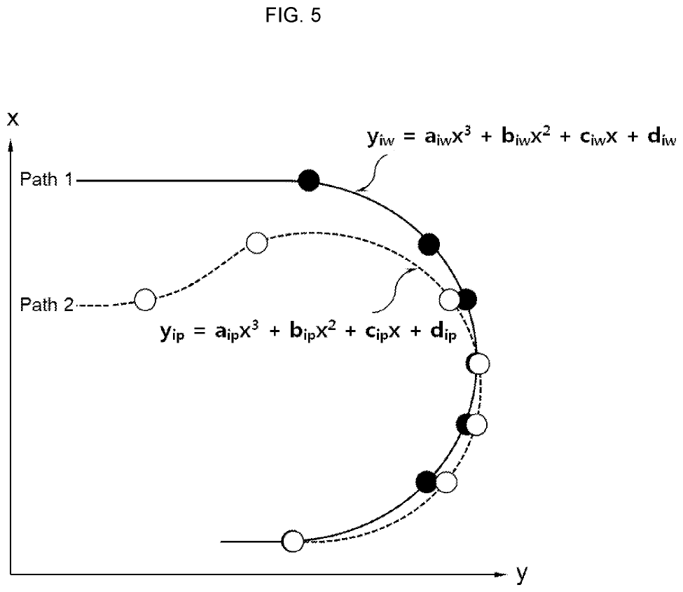

Accordingly, the reference path may be dynamically corrected by estimation of the reliability of the driving environment information, and the reliability of the U-turn path, which will be described below, may be enhanced. The path comparison determiner 150 may be configured to compare the reference path and the candidate path to generate an optimum U-turn path, which will be described with reference to FIG. 5. FIG. 5 is a diagram illustrating a method of generating an optimum U-turn path by a U-turn path generating apparatus according to an exemplary embodiment of the present disclosure.

Referring to FIG. 5, the path comparison determiner 150 may be configured to calculate an error between coefficients of the first path equation y_{iw} of a reference path (path 1) and the second path equation yᵢₚ of the candidate path (path 2) for each path section and may compare whether the error is greater than a predetermined threshold value. For example, the threshold value refers to minimum reliability of a path difference between the reference path and the candidate path, and the error between the coefficients between the first and second path equations y_{iw} and yᵢₚ for each path section may be represented according to Equation 3 below.

Equation 3

eₐᵢ=a_{iw}−aᵢₚ (1)

e_{bi}=b_{iw}−bᵢₚ (2)

e_{ci}=c_{iw}−cᵢₚ (3)

e_{di}=d_{iw}−dᵢₚ (4)

wherein, i is a path section, e is an error between coefficients of first and second path equations, aᵢ is a curvature rate of an i^{th} path section, bᵢ is a curvature of an i^{th} path section, cᵢ is a heading angle of a vehicle of an i^{th} path section or a preceding vehicle, and dᵢ is a lateral offset.

When errors eₐᵢ, e_{bi}, e_{ci}, and e_{di} between coefficients for each path section are equal to or greater than preset threshold values βₐ, β_{b}, β_{c}, and β_{d}, the path comparison determiner 150 may be configured to generate a U-turn path through curve fitting of a polynomial for each path section based on the second path equation yᵢₚ.

In contrast, when the errors eₐᵢ, e_{bi}, e_{ci}, e_{di} between coefficients for each path section are less than the preset threshold values βₐ, β_{b}, β_{c} and β_{d}, the path comparison determiner 150 may be configured to generate the U-turn path through curve fitting of a polynomial for each path section based on the first path equation y_{iw}. In particular, the U-turn path may also be generated by combining the first and second path equations y_{iw} and yᵢₚ for each path section. The vehicle controller 160 may be configured to execute U-turn driving of a vehicle according to an optimum U-turn path through the aforementioned path comparison determiner 150.

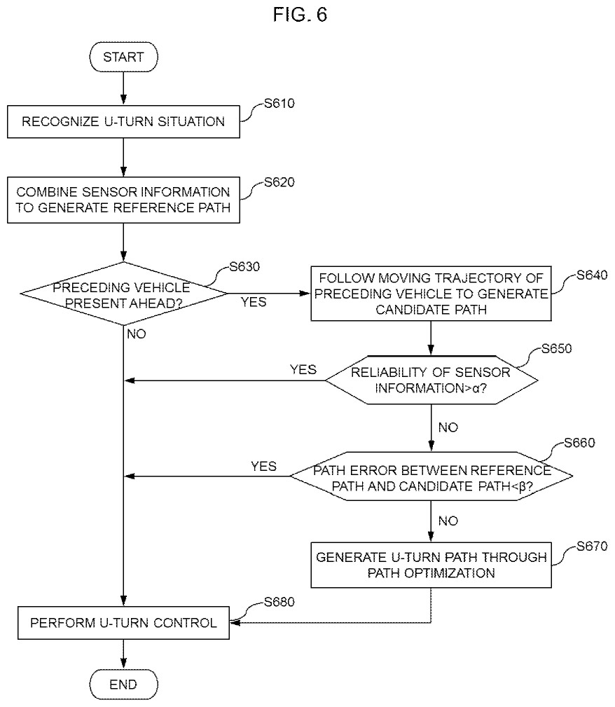

Hereinafter, a method of generating a U-turn path according to an exemplary embodiment of the present disclosure will be described with reference to FIG. 6. FIG. 6 is a flowchart illustrating a method of generating a U-turn path of an autonomous vehicle according to an exemplary embodiment of the present disclosure. The method described herein below may be executed by the controller.

Referring to FIG. 6, the U-turn path generating method according to an exemplary embodiment may include recognizing a U-turn situation (S610), combining sensor information to generate a reference path (S620), determining whether a preceding vehicle is present ahead of a vehicle (S630), following a moving trajectory of the preceding vehicle to generate a candidate path (S640), determining the reliability of sensor information (S650), comparing the reference path and the candidate path (S660), generating a U-turn path by optimizing a path (S670), and performing U-turn control according to the generated U-turn path (S680).

In operation S610, the U-turn path generating apparatus 100 may be configured to collect driving environment information through the GPS receiver 10, the map DB 20, the navigation device 30, and the sensor unit 40, which are installed in the vehicle, and may be configured to recognize a U-turn situation based on the driving environment information. In operation S620, the U-turn path generating apparatus 100 may be configured to generate a plurality of virtual path points on a high definition map based on the driving environment information, and calculate a first path equation based on an n^{th} degree polynomial (where n is a natural number equal to or more than 3) for each path section between adjacent virtual path points of the plurality of virtual path points to generate the reference path.

In operation S630, the U-turn path generating apparatus 100 may be configured to determine whether a preceding vehicle is present ahead of a vehicle (e.g., a subject vehicle) based on image information acquired through the image sensor 41. As the determination result, in response to determining that a preceding vehicle is not present ahead of the vehicle (NO of S630), U-turn control of the vehicle may be performed according to the reference path (S680).

In contrast, in response to determining that the preceding vehicle is not present ahead of the vehicle (YES of S630), a moving trajectory of the preceding vehicle may be followed to extract a plurality of follow path points, and the second path equation based on the n^{th} degree polynomial (where n is a natural number equal to or more than 3) for each path section between adjacent follow path points of the plurality of follow path points may be calculated to generate the candidate path in operation S640.

Then, in operation S650, the U-turn path generating apparatus 100 may be configured to determine whether the reliability of sensor information is less than a preset reference value α. When the reliability of the sensor information is equal to or greater than the reference a (YES of S650), a viewing angle of the sensor may be considered to be ensured at a predetermined level, and U-turn control of the vehicle may be performed according to the reference path (S680).

In contrast, when the reliability of the sensor information is less than the preset reference value α (NO of S650), the U-turn path generating apparatus 100 may be configured to determine whether a path error between the reference path and the candidate path is equal to or greater than a preset threshold value β in operation S660. In particular, the U-turn path generating apparatus 100 may be configured to calculate an error between coefficients between the first path equation of the reference path and the second path equation of the candidate path for each path section and may be configured to compare whether the error is greater than a predetermined threshold value.

As the determination result, when the error between coefficients for each path section is equal to or greater than a preset threshold value β (NO of S660), the U-turn path generating apparatus 100 may be configured to generate a U-turn path through curve fitting of a polynomial for each path section based on the second path equation and optimize a path (S670) and may be configured to operate the vehicle to the corrected U-turn path (S680).

In contrast, when the error between coefficients for each path section is less than the preset threshold value β (YES of S660), the U-turn path generating apparatus 100 may be configured to perform curve fitting of a polynomial for each path section based on the first path equation and perform U-turn control of the vehicle according to the reference path (S680).

Accordingly, according to at least one exemplary embodiment of the present disclosure, a U-turn path may be generated based on sensor information, in which case a moving trajectory of a preceding vehicle and determination of the reliability of a sensor may be applied to dynamically correct a path, and thus, the reliability of the path may be enhanced, and the vehicle may be actively controlled in various U-turn interruption situations.

It will be appreciated by persons skilled in the art that that the effects that could be achieved with the present disclosure are not limited to what has been particularly described hereinabove and other advantages of the present disclosure will be more clearly understood from the detailed description.

The aforementioned method of generating a U-turn path of an autonomous vehicle may be prepared as a program to be executed in a computer and may be stored in a non-transitory computer readable recording medium, and examples of the non-transitory computer readable recording medium include read-only memory (ROM), random-access memory (RAM), CD-ROMs, magnetic tapes, hard disks, floppy disks, flash memory, optical data storage devices, and so on.

The non-transitory computer readable recording medium may also be distributed over network coupled computer systems so that the computer readable code is stored and executed in a distributed fashion. Additionally, functional programs, code, and code segments for accomplishing the present disclosure may be easily construed by programmers skilled in the art to which the present disclosure pertains.

Although some cases have been described above in relation to exemplary embodiments, the exemplary embodiments may be changed in various forms. The aforementioned technological features of the exemplary embodiments may be embodied in various forms as long as they are not incompatible, new exemplary embodiments may be embodied therethrough.

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

What is claimed is:

1. A method of generating a U-turn path of an autonomous vehicle, comprising:
recognizing, by a controller, a U-turn situation;
generating, by the controller, a plurality of virtual path points on a high definition map based on driving environment information and generating a reference path corresponding to the U-turn situation;
in response to detecting a preceding vehicle is present ahead of the vehicle, following, by the controller, a moving trajectory of the preceding vehicle and generating a candidate path; and
comparing, by the controller, the reference path with the candidate path and generating an optimum U-turn path.

2. The method of claim 1, wherein generating the reference path includes:
calculating, by the controller, a first path equation based on an n^{th} degree polynomial for each path section between adjacent virtual path points of the plurality of virtual path points.

3. The method of claim 2, wherein calculating the first path equation includes calculating a coefficient of the first path equation for each path section using position coordinates and a heading angle of the vehicle and a curvature and curvature rate at each of the virtual path points.

4. The method of claim 3, wherein generating the candidate path includes:
generating, by the controller, a contour corresponding to the preceding vehicle based on data collected using a distance measuring sensor; and
extracting, by the controller, a center point of the contour, accumulating and acquiring position coordinates of the center point for each time sampling, and generating the moving trajectory of the preceding vehicle.

5. The method of claim 4, wherein generating the candidate path includes:
extracting, by the controller, a plurality of follow path points corresponding to a plurality of virtual path points, respectively, from the moving trajectory of the preceding vehicle; and
calculating, by the controller, a second path equation based on an n^{th} degree polynomial for each path section between adjacent follow path points among the plurality of follow path points.

6. The method of claim 5, wherein generating the optimum U-turn path includes:
calculating, by the controller, an error between coefficients of the first and second path equations for each path section; and
in response to determining that the error is equal to or greater than a preset threshold value, generating, by the controller, the U-turn path through curve fitting of a polynomial for each path section based on the second path equation.

7. The method of claim 6, wherein generating the optimum U-turn path includes:
in response to determining that the error is less than the preset threshold value, generating, by the controller, the U-turn path through curve fitting of a polynomial for each path section based on the first path equation.

8. The method of claim 1, further comprising:
estimating, by the controller, reliability of the driving environment information,
wherein the generating the optimum U-turn path includes, in response to determining that the reliability is less than a preset reference value, comparing the reference path with the candidate path.

9. The method of claim 8, wherein determining the reliability includes determining the reliability of the driving environment information based on a field of view of each sensor and a blind spot due to a surrounding vehicle.

10. A non-transitory computer-readable recording medium having recorded thereon an application program for executing the method of generating the U-turn path of the autonomous vehicle of claim 1 by executing the method by a processor.

11. A U-turn path generating apparatus of an autonomous vehicle, comprising:
a driving situation recognizer configured to recognize a U-turn situation;
a reference path generator configured to generate a plurality of virtual path points on a high definition map based on a combination result of driving environment information and to generate a reference path corresponding to the U-turn situation;
a candidate path generator configured, when a preceding vehicle is present ahead of the vehicle, to follow a moving trajectory of the preceding vehicle and to generate a candidate path; and
a path comparison determiner configured to compare the reference path with the candidate path and to generate an optimum U-turn path.

12. The U-turn path generating apparatus of the autonomous vehicle of claim 11, wherein the reference path generator is configured to calculate a first path equation based on an n^{th} degree polynomial for each path section between adjacent virtual path points of the plurality of virtual path points.

13. The U-turn path generating apparatus of the autonomous vehicle of claim 12, wherein the reference path generator is configured to calculate a coefficient of the first path equation for each path section using position coordinates and a heading angle of the vehicle and a curvature and curvature rate at each of the virtual path points.

14. The U-turn path generating apparatus of the autonomous vehicle of claim 13, wherein the candidate path generator is configured to generate a contour corresponding to the preceding vehicle based on data collected using a distance measuring sensor, extract a center point of the contour, accumulate and acquire position coordinates of the center point for each time sampling, and generate the moving trajectory of the preceding vehicle.

15. The U-turn path generating apparatus of the autonomous vehicle of claim 14, wherein the candidate path generator is configured to extract a plurality of follow path points corresponding to a plurality of virtual path points, respectively, from the moving trajectory of the preceding vehicle, and calculate a second path equation based on an n^{th} degree polynomial for each path section between adjacent follow path points among the plurality of follow path points.

16. The U-turn path generating apparatus of the autonomous vehicle of claim 15, wherein the path comparison determiner is configured to calculate an error between coefficients of the first and second path equations for each path section, and, in response to determining that the error is equal to or greater than a preset threshold value, the path comparison determiner is configured to generate the U-turn path through curve fitting of a polynomial for each path section based on the second path equation.

17. The U-turn path generating apparatus of the autonomous vehicle of claim 16, wherein, in response to determining that the error is less than the preset threshold value, the path comparison determiner is configured to generate the U-turn path through curve fitting of a polynomial for each path section based on the first path equation.

18. The U-turn path generating apparatus of the autonomous vehicle of claim 11, further comprising:
a reliability estimator configured to estimate reliability of the driving environment information,
wherein, in response to determining that the reliability is less than a preset reference value, an operation of the path comparison determiner is initiated.

19. The U-turn path generating apparatus of the autonomous vehicle of claim 18, wherein the reliability estimator is configured to determine the reliability of the driving environment information in consideration of a field of view of each sensor and a blind spot due to a surrounding vehicle.
